(19) United States
(12) Patent Application Publication
(10) Pub. No.: US 2003/0028639 A1
(43) Pub. Date: Feb. 6, 2003

(54) Access control system

(76) Inventors: Masaya Yamamoto, Hirakata (JP); Ryuichi Okamoto, Moriguchi (JP); Masahiro Oho, Neyagawa (JP)

Correspondence Address: WENDEROTH, LIND & PONACK, L.L.P., 2033 K STREET N. W., SUITE 800, WASHINGTON, DC, 20006-1021, US

(21) Appl. No.: 10/208,751

(22) Filed: Aug. 1, 2002

(30) Foreign Application Priority Data
Aug. 3, 2001 (JP) 2001-236030

(51) Int. Cl. G06F 15/173

(52) U.S. Cl. 709/225

(57) ABSTRACT

An access control system includes a server 11, an access management database storage device 12, first and second client devices 13 and 15, and data storage devices 14 and 16. The first and second client devices 13 and 15 forms a peer-to-peer file exchange system, and can access the server 11. The access management database storage device 12 stores an access management list. When receiving a request for data from the second client device 15, the first client device 13 inquires the server 11 about whether the requested data can be accessed. The server 11 determines whether the data can be accessed by using the access management list.

### BACKGROUND OF THE INVENTION

1. Field of the Invention

The present invention relates to an access control system for peer-to-peer data exchange over a network.

2. Description of the Background Art

In recent years, peer-to-peer computing has been drawing attention. Peer-to-peer computing is a technique enabling devices connected to each other through a network to directly exchange data, thereby sharing computer resources (CPU power, hard disc space, etc.) and various services (message exchange system, file exchange system, etc.), and even enabling collaboration between the devices. In such peer-to-peer file exchange system, devices of the end-users (client devices) can directly communicate with each other to exchange files managed by the devices.

In the peer-to-peer file exchange system, whether a file managed by a client device can be accessed by another client device is determined by the client device itself. Access control carried out by a client device to be accessed (data-provider device) is exemplarily carried out as follows: The data-provider device requests an accessing client device (data-destination device) for a password, and only when the password transmitted from the data-destination device is valid, the data-provider device allows the file managed by itself to be accessed. The data-provider device can further carry out even complex access control by using an access date and/or identifier of the data-destination device, or by setting control information unique to each file managed by the data-provider device.

Such complex access control can be easily achieved if the data-provider device is implemented by a personal computer having a high processing capability, but is very difficult if it is implemented by a consumer-electronics product having a limited processing capability. Moreover, unlike the personal computer, it is extremely difficult to replace software installed in the consumer-electronics product after purchase. Therefore, it is hardly possible to add or change the scheme of access control as described above.

For another access control, a server communicably connected to the above-described file exchange system is provided to manage files stored in the client devices of the system as a list. The list managed by this server contains names of files and client devices that manages these files. The client device in the system refers to the list to know whether a desired file exists in the system and, if it exists, which client manages the file. This server, however, cannot carry out access control as described above. In this case, access control is carried out by the data-provider device that manages the desired file.

### SUMMARY OF THE INVENTION

Therefore, an object of the present invention is to provide an access control system capable of carrying out desired access control in a client device of a peer-to-peer file exchange system.

The present invention has the following features to attain the object mentioned above.

A first aspect of the present invention is directed to an access control system in which, when a client device of an end-user is requested from another device to directly transmit data stored in the client device, it is determined whether the data can be accessed. The access control system includes the client devices and a server. The server is communicably connected to the client device, and manages an access management list containing which data can be accessed. The server includes an access enable/disable determining unit operable to determine, in response to a data access inquiry, whether the data can be accessed with reference to the access management list and sending a determination result. The client device includes an access enable/disable inquiring unit and a data transmitting unit. The access enable/disable inquiring unit gives the access enable/disable determining unit the data access inquiry of whether the data can be accessed when the other device requests the client device to directly transmit the data. The data transmitting unit directly transmits the requested data to the other device when the determination result received from the access enable/disable determining unit indicates that the data can be accessed.

According to the first aspect, the data-provider client device gives an access inquiry to the server. With this, access control for peer-to-peer data exchange is carried out by the server, which is high in processing capability. Therefore, it is possible to appropriately carry out even complex access control. With complex access control being achieved, data itself is directly exchanged between the client devices, thereby enabling data exchange without imposing a large load on the band of the network. Furthermore, even if the client device is implemented by a consumer-electronics product having a limited processing capability, the above complex access control is carried out by the server. Therefore, peer-to-peer data exchange between consumer-electronics products having a limited processing capability can be easily carried out by adding the above complex access control thereto.

Also, the access management list managed by the server may contain which device can access which data managed by the client device. In this case, the access enable/disable inquiring unit gives the access enable/disable determining unit the data access inquiry for each data requested to be transmitted. In response to the data access inquiry given by the access enable/disable inquiring unit, the access enable/disable determining unit determines whether the data can be accessed, and sends the determination result. Thus, it is possible to set each data managed by the client device as to whether the data can be accessed or not.

The access management list managed by the server further contains, as a first condition, a time condition indicating an accessible time for each data. In this case, the access enable/disable determining unit determines whether the data can be accessed by referring to the time condition based on a time when the data access inquiry is received from the access enable/disable inquiring unit. Thus, it is possible to set each data managed by the client device as to whether the data can be accessed or not under the condition indicating the accessible time.

The access management list managed by the server further contains, as a second condition, a number-of-times condition indicating the number of times of allowable access for each data. In this case, the access enable/disable determining unit determines whether the data can be accessed by referring to the number-of-times condition based on how many times the data has been accessed. Thus, it is possible to set each data managed by the client device as to whether the data can be accessed or not under the condition indicating the number of times of allowable access.

The access management list managed by the server further contains, as a third condition, a duplicate condition indicating a duplication limitation provided for each data. In this case, in response to the data access inquiry given by the access enable/disable inquiring unit, the access enable/disable determining unit determines whether the data can be accessed, and sends the determination result and the duplicate condition. Then, the data transmitting unit directly transmits the requested data with the duplicate condition to the other device when the determination result received from the access enable/disable determining unit indicates that the data can be accessed. Thus, it is possible to provide each data managed by the client device with the duplicate limitation after accessed.

Alternatively, the server may be communicably connected to the client device through a proxy device. Thus, even if the data-provider client device and the server cannot directly communicate with each other, it is possible to inquire about whether the data can be accessed through the proxy device. With this, access control for peer-to-peer data exchange is carried out by the server, which is high in processing capability.

Alternatively, the access enable/disable inquiring unit may give the access enable/disable determining unit the data access inquiry together with a first certificate that certifies the client device and a second certificate that certifies the other device. In this case, the access enable/disable determining unit authenticates the data access inquiry given by the access enable/disable inquiring unit by using the first and second certificates, then determines whether the data can be accessed and sends the determination result. By authenticating the first and second certificates, the server can confirm that communications has been made from the authorized client device.

The certificates may be X.509 certificates. In this case, by using such X.509 certificates, the server can easily and reliably confirm that communications has been made from the authorized client device.

A second aspect of the present invention is directed to an access control system in which, when a first client device of an end-user is requested from a second client device to directly transmit data stored in the first client device, it is determined whether the data can be accessed. The access control system includes the first and second client devices and a server. The server is communicably connected to at least the second client device, and manages an access management list containing which data can be accessed. The server includes an access enable/disable determining unit operable to determine, in response to a data access inquiry, whether the data can be accessed with reference to the access management list and send a determination result. The second client device includes an access enable/disable inquiring unit, a data requesting unit, and a data receiving unit. The access enable/disable inquiring unit gives the access enable/disable determining unit the data access inquiry about whether the data can be accessed when the second client device requests the first client device to directly transmit the data. The data requesting unit gives a request to the first client device for directly transmitting the data together with the determination result received from the access enable/disable determining unit when the determination result indicates that the data can be accessed. The first client device includes a data transmitting unit for directly transmitting the data requested by the data requesting unit to the second client device when the determination result received from the data requesting unit indicates that the data can be accessed. The data receiving unit directly receives the data transmitted from the data transmitting unit in response to the request given by the data requesting unit.

According to the second aspect, the second client device, which is the data-destination client device, gives an access inquiry to the server. With this, access control for peer-to-peer data exchange is carried out by the server, which is high in processing capability. Therefore, it is possible to appropriately carry out even complex access control. With complex access control being achieved, data itself is directly exchanged between the client devices, thereby enabling data exchange without imposing a large load on the band of the network. Furthermore, even if the client device is implemented by a consumer-electronics product having a limited processing capability, the above complex access control is carried out by the server. Therefore, peer-to-peer data exchange between consumer-electronics products having a limited processing capability can be easily carried out by adding the above complex access control thereto.

Also, the access management list managed by the server may contain which client device can access which data. In this case, the access enable/disable inquiring unit gives the access enable/disable determining unit the data access inquiry for each data requested for transmission. In response to the data access inquiry given by the access enable/disable inquiring unit, the access enable/disable determining unit determines whether the data can be accessed, and sends the determination result.

The access management list managed by the server further contains, as a first condition, a time condition indicating an accessible time for each data. In this case, the access enable/disable determining unit determines whether the data can be accessed by referring to the time condition based on a time when the data access inquiry is received from the access enable/disable inquiring unit.

The access management list managed by the server further contains, as a second condition, a number-of-times condition indicating the number of times of allowable access for each data. In this case, the access enable/disable determining unit determines whether the data can be accessed by referring to the number-of-times condition based on how many times the data has been accessed.

The access management list managed by the server further contains, as a third condition, a duplicate condition indicating a duplication limitation provided for each data. In this case, in response to the data access inquiry given by the access enable/disable inquiring unit, the access enable/disable determining unit determines whether the data can be accessed, and sends the determination result and the duplicate condition. Then, the data requesting unit gives the request to the first client device for directly transmitting the data, together with the determination result and the duplicate condition when the determination result received from the access enable/disable determining unit indicates that the data can be accessed. When the determination result received from the data requesting unit indicates that the data can be accessed, the data transmitting unit directly transmits, to the data receiving unit, the data requested from the data requesting unit and the duplicate condition. Then, the data receiving unit directly receives the data transmitted from the data transmitting unit, the data restricted in further duplication by the duplication condition. Thus, even if the second client device, which is the data-destination client device, inquires the server about whether the data can be accessed, it is possible to provide each data managed by the client device with the duplicate limitation after accessed.

Alternatively, the server may be communicably connected to the second client device through a proxy device. Thus, even if the server and the second client device that inquires the server cannot directly communicate with each other, it is possible to inquire about whether the data can be accessed through the proxy device. With this, access control for peer-to-peer data exchange is carried out by the server, which is high in processing capability.

Alternatively, the access enable/disable inquiring unit may give the access enable/disable determining unit the data access inquiry to request the first client device for directly transmitting the data, together with a certificate that certifies the second client device. In this case, the access enable/disable determining unit authenticates the data access inquiry given by the access enable/disable inquiring unit by using the certificate, then determines whether the data can be accessed and then sends the determination result. By authenticating the certificate, the server can confirm that communications has been made from the authorized second client device. Alternatively, the access enable/disable determining unit may send the determination result affixed with a signature for certifying that the determination result is from the server. In this case, the data requesting unit gives the first client device a request for directly transmitting the data together with the determination result affixed with the signature and the certificate, when the determination result received from the access enable/disable determining unit indicates that the data can be accessed. Then, the data transmitting unit first authenticates the determination result received from the data requesting unit by using the signature affixed thereto, and then directly transmits, to the data receiving unit, the data requested from the data requesting unit and the duplicate condition, when the determination result indicates that the data can be accessed. With this signature, it is possible to prevent tampering during communications of the determination result. Also, the first client device can determine that the determination result surely comes from the server. Furthermore, the certificates may be X.509 certificates.

A third aspect of the present invention is directed to a server for determining whether data managed by a plurality of client devices of end-users can be accessed when the data is directly transmitted and received among the client devices. The server includes an access managing unit and an access enable/disable determining unit. The access managing unit manages an access management list containing which data can be accessed by which client device. The access enable/disable determining unit determines, in response to a data access inquiry given by one client device, whether the data can be accessed with reference to the access management list managed by the access managing unit, and sends a determination result to the client device that has given the data access inquiry.

According to the third aspect, access control for peer-to-peer data exchange is carried out by the server, which is high in processing capability, when inquired by the client device to carry out data exchange. Therefore, it is possible to appropriately carry out even complex access control.

A fourth aspect of the present invention is directed to a client device of an end-user, the client device causing a communicable server to determine whether data stored in the client device can be accessed when another device gives the client device a request for directly transmitting the data, the server managing an access management list that contains which data can be accessed. The client device includes an access enable/disable inquiring unit and a data transmitting unit. The access enable/disable inquiring unit gives the server an inquiry about whether the data can be accessed when the other device gives the client device the request for directly transmitting the data. The data transmitting unit directly transmits the data as requested by the other device when the server determines, in response to the inquiry given by the access enable/disable inquiring unit, that the data can be accessed.

According to the fourth aspect, access control for peer-to-peer data exchange is carried out by the server, which is high in processing capability, when inquired by the client device that is requested to transmit the data. Therefore, it is possible to construct a client device capable of appropriately carrying out complex access control. Furthermore, even if the data-provider client device is implemented by a consumer-electronics product having a limited processing capability, the above complex access control is carried out by the server. Therefore, peer-to-peer data exchange between consumer-electronics products having a limited processing capability can be easily carried out by adding the above complex access control thereto.

A fifth aspect is directed to a client device of an end-user, the client device causing a communicable server to determine whether data stored in another device can be accessed when the client device gives the other device a request for direct transmitting the data, the server managing an access management list that contains which data can be accessed. The client device includes an access enable/disable inquiring unit and a data requesting unit. The access enable/disable inquiring unit gives the server an inquiry about whether the data can be accessed when the client device gives the other device the request for directly transmitting the data. When a determination result received from the server indicates that the data can be accessed in response to the inquiry given by the access enable/disable inquiring unit, the data requesting unit gives the other device the request for directly transmitting the data, and also gives the determination result.

According to the fifth aspect, access control for peer-to-peer data exchange is carried out by the server, which is high in processing capability, when inquired by the client device that gives a request for transmitting the data. Therefore, it is possible to construct a client device capable of appropriately carrying out complex access control. Furthermore, even if the data-provider client device and the data-destination client device are implemented by consumer-electronics products having a limited processing capability, the above complex access control is carried out by the server. Therefore, peer-to-peer data exchange between consumer-electronics products having a limited processing capability can be easily carried out by adding the above complex access control thereto.

A sixth aspect is directed to a client device of an end-user for directly transmitting data upon request from another device. The client device includes a receiving unit and a data transmitting unit. The receiving unit receives a request from the other device for directly transmitting the data, and a determination result indicating whether the data can be accessed. The data transmitting unit directly transmits the data requested by the other device when the determination result received by the receiving unit indicates that the data can be accessed.

According to the sixth aspect, the determination result in peer-to-peer data exchange is transmitted together with a request for transmitting the data. Thus, the client device that is requested to transmit the data can determine whether the data can be accessed based on the determination result. Therefore, it is possible to construct a client device capable of appropriately carrying out complex access control. Furthermore, even if the data-provider client device is implemented by a consumer-electronics product having a limited processing capability, the data-provider client device does not have to carry out access control. Therefore, peer-to-peer data exchange between consumer-electronics products having a limited processing capability can be easily carried out by adding the above complex access control thereto.

Also, the determination result may be provided with a signature certifying the authenticity of the determination result. In this case, the data transmitting unit evaluates authenticity of the determination result by authenticating the signature provided on the determination result and, when the determination result is valid and indicates that the data can be accessed, directly transmits the data requested by the other device. With this signature provided on the determination result transmitted together with a request for transmitting data in peer-to-peer data exchange, it is possible to prevent tampering during communications of the determination result. Also, the data-provider client device can surely evaluate authenticity of the determination result.

A seventh aspect is directed to an access control method for causing, when a client device of an end-user is requested from another device to directly transmit data stored in the client device, a server communicably connected to the client device to determine whether the data can be accessed. The access control method includes an access managing step, an access enable/disable inquiring step, an access enable/disable determining step, and a data transmitting step. In the access managing step, an access management list containing which data can be accessed is managed by the server. In the access enable/disable inquiring step, the server is given by the client device an inquiry about whether the data requested from the other device for direct transmission can be accessed. In the access enable/disable determining step, it is determined by the server whether the data can be accessed with reference to the access management list managed in the access managing step in response to the inquiry in the inquiring step, and a determination result is sent to the client device. In the data transmitting step, the requested data is directly transmitted from the client device to the other device when the determination result obtained in the determining step indicates that the data can be accessed.

According to the seventh aspect, the data-provider client device gives an access inquiry to the server. With this, access control for peer-to-peer data exchange is carried out by the server, which is high in processing capability. Therefore, it is possible to appropriately carry out even complex access control. With complex access control being achieved, data itself is directly exchanged between the client devices, thereby enabling data exchange without imposing a large load on the band of the network. Furthermore, even if the client device is implemented by a consumer-electronics product having a limited processing capability, the above complex access control is carried out by the server. Therefore, peer-to-peer data exchange between consumer-electronics products having a limited processing capability can be easily carried out by adding the above complex access control thereto.

An eighth aspect is directed to an access control method for causing, when a first client device of an end-user is requested from a second client device to directly transmit data stored in the first client device, a server communicably connected to a second client device to determine whether the data can be accessed. The access control method includes an access managing step, an access enable/disable inquiring step, an access enable/disable determining step, a request giving step, a data transmitting step, and a data receiving step. In the access managing step, an access management list containing which data can be accessed is managed by the server. In the access enable/disable inquiring step, the server is given by the second client device an inquiry about whether the data requested from the second client device to the first client device for direct transmission can be accessed. In the access enable/disable determining step, it is determined by the server whether the data can be accessed with reference to the access management list managed in the access managing step in response to the inquiry in the inquiring step, and sending a determination result to the second client device. In the request giving step, to the first client device, a request is given for directly transmitting the data and the determination result when the determination result sent in the determining step indicates that the data can be accessed. In the data transmitting step, the data requested in the request giving step is directly transmitted from the first client device to the second client device when the determination result given in the request giving step indicates that the data can be accessed. In the data receiving step, the data transmitted from the first client device in the data transmitting step is directly received by the second client device.

According to the eighth aspect, the second client device, which is the data-destination client device, gives an access inquiry to the server. With this, access control for peer-to-peer data exchange is carried out by the server, which is high in processing capability. Therefore, it is possible to appropriately carry out even complex access control. With complex access control being achieved, data itself is directly exchanged between the client devices, thereby enabling data exchange without imposing a large load on the band of the network. Furthermore, even if the client device is implemented by a consumer-electronics product having a limited processing capability, the above complex access control is carried out by the server. Therefore, peer-to-peer data exchange between consumer-electronics products having a limited processing capability can be easily carried out by adding the above complex access control thereto.

A ninth aspect is directed to a recording medium recording an access control program for causing, when data managed by client devices of end-users is directly transmitted and received among the client devices, a server communicably connected to the client devices to determine whether the data can be accessed. The program readable by the server includes an access managing step and an access enable/disable determining step. In the access managing step, an access management list containing which data can be accessed by the respective client devices is managed. In the access enable/disable determining step, it is determined whether the data can be accessed with reference to the access management list managed in the access managing step in response to a data access inquiry from the client device to the server as to direct transmission and reception of the data, and sending a determination result to the client device.

According to the ninth aspect, access control for peer-to-peer data exchange is carried out by the server, which is high in processing capability. By giving the server an access inquiry from the client device for data exchange, it is possible to appropriately carry out even complex access control.

A tenth aspect is directed to a recording medium recording an access control program for causing, when a client device of an end-user is request from another device to directly transmit data stored in the client device, a communicable server to determine whether the data can be accessed, by using an access management list containing which data can be accessed. The recording medium readable by the client device includes an access enable/disable inquiring step and a data transmitting step. In the access enable/disable inquiring step, the server is given an inquiry about whether the data can be accessed when the client device is requested from the other device to directly transmit the data. In the data transmitting step, the requested data is directly transmitted from the client device to the other device when a determination result received from the server indicates that the data can be accessed in response to the inquiry given in the inquiry giving step.

According to the tenth aspect, access control for peer-to-peer data exchange is carried out by the server, which is high in processing capability. By giving the server an access inquiry from the client device that is requested to transmit the data, it is possible to appropriately carry out even complex access control. Furthermore, even if the data-provider client device is implemented by a consumer-electronics product having a limited processing capability, the above complex access control is carried out by the server. Therefore, peer-to-peer data exchange between consumer-electronics products having a limited processing capability can be easily carried out by adding the above complex access control thereto.

An eleventh aspect is directed to a recording medium recording an access control program for causing, when a client device of an end-user requests another device to directly transmit data stored in the other device, a communicable server to determine whether the data can be accessed, by using an access management list containing which data can be accessed. The recording medium readable by the client device includes an access enable/disable inquiring step and a request giving step. In the access enable/disable inquiring step, the server is given an inquiry about whether the data can be accessed when the client device requests the other device to directly transmit the data. In the request giving step, the other device is directly given a request for directly transmitting the data together with a determination result received from the server, when the determination result indicates that the data can be accessed in response to the inquiry given in the access enable/disable inquiring step.

According to the eleventh aspect, access control for peer-to-peer data exchange is carried out by the server, which is high in processing capability. By giving the server an access inquiry from the client device that requests for data transmission, it is possible to appropriately carry out even complex access control. Furthermore, even if the data-provider client device and the data-destination client device are implemented by consumer-electronics products having a limited processing capability, the above complex access control is carried out by the server. Therefore, peer-to-peer data exchange between consumer-electronics products having a limited processing capability can be easily carried out by adding the above complex access control thereto.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an illustration for demonstrating the entire construction of an access control system according to a first embodiment of the present invention;

FIG. 2 is a functional block diagram showing the internal construction of a server 11 illustrated in FIG. 1;

FIG. 3 is a functional block diagram showing the internal construction of a first client device 13 illustrated in FIG. 1;

FIG. 4 is a functional block diagram showing the internal construction of a second client device 15 illustrated in FIG. 1;

FIG. 5 is a flowchart showing the entire operation by the server 11 and the first and second client devices 13 and 15 illustrated in FIG. 1;

FIG. 6 is an illustration for demonstrating the data structure of an access management list stored in an access management database storage device 12 illustrated in FIG. 1;

FIG. 7 is a subroutine illustrating one example of the detailed operation of an access determining process carried out by an access enable/disable determining unit 111 in step S11 of FIG. 5;

FIG. 8 is a subroutine illustrating another example of the detailed operation of an access determining process carried out by an access enable/disable determining unit 111 in step S11 of FIG. 5;

FIG. 9 is an illustration for demonstrating the entire construction of an access control system according to a second embodiment of the present invention;

FIG. 10 is a functional block diagram showing the internal construction of a server 21 illustrated in FIG. 9;

FIG. 11 is a functional block diagram showing the internal construction of a first client device 23 illustrated in FIG. 9;

FIG. 12 is a functional block diagram showing the internal construction of a second client device 25 illustrated in FIG. 9; and

FIG. 13 is a flowchart showing the entire operation carried out by the server 21 and the first and second client devices 23 and 25 illustrated in FIG. 9.

### DESCRIPTION OF THE PREFERRED EMBODIMENTS

(First Embodiment)

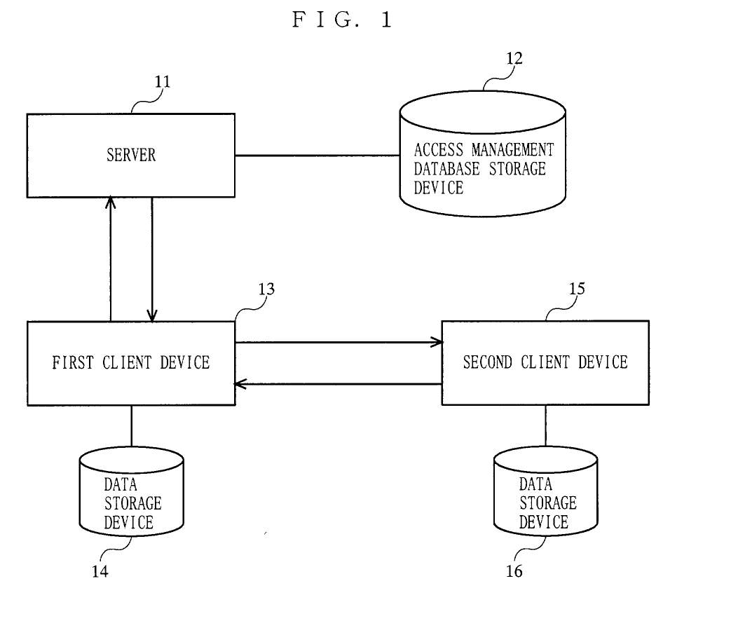

With reference to FIG. 1, described is the entire configuration of an access control system according to a first embodiment of the present invention. In FIG. 1, the access control system includes a server 11, an access management database storage device 12, a first client device 13, a data storage device 14, a second client device 15, and a data storage device 16. The first and second client devices 13 and 15 are end-users' devices each having a CPU and achieving peer-to-peer computing by direct communications with each other, thereby achieving a peer-to-peer file exchange system. The server 11 is communicably connected to the client device placed in the peer-to-peer file exchange system, and can be accessed by at least the first client device 13. The data storage devices 14 and 16 are storage devices each storing files managed by the first and second client devices 13 and 15, respectively, and others. The access management database storage device 12 is a storage device that stores an access management list (will be described later) managed by the server 11, and other data.

In the present embodiment, for the sake of simplification, it is assumed that the second client device 15 accesses the first client device 13 to receive a desired file stored in the data storage device 14 managed by the first client device 13. Therefore, the first client device 13 is a data-provider client device, while the second client device 15 is a data-destination device. Also, in the access control system, two or more client devices can be placed, but only the client devices engaging the above-described file access are described.

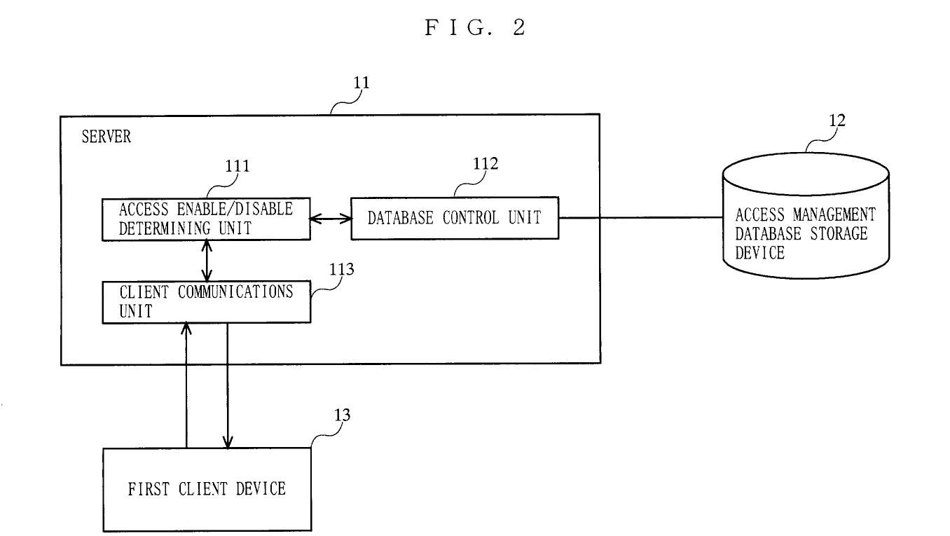

Next, with reference to FIG. 2, the internal construction of the server 11 is described. FIG. 2 is a functional block diagram illustrating the internal construction of the server 11. In FIG. 2, the server 11 includes an access enable/disable determining unit 111, a database control unit 112, and a client communications unit 113. The client communications unit 113 uses a protocol such as TCP/IP to carry out communications between the first client device 13 and the server 11. The database control unit 112 controls the data stored in the access management database storage device 12. For example, the database control unit 112 searches the access management database storage device 12 for specific data requested by the access enable/disable determining unit 111, and updates the data after search. Also, the database control unit 112 adds new data to or deletes the existing data from the data stored in the access management database storage device 12 upon request from the client device via the client communications unit 113. Upon request from the first client device 13 via the client communications unit 113, the access enable/disable determining unit 111 refers to the access management list stored in the access management database storage device 12 to return the determination result to the client communications unit 113. Depending on the determination result, when the access management list has to be updated, the access enable/disable determining unit 111 instructs the database control unit 112 to update the list.

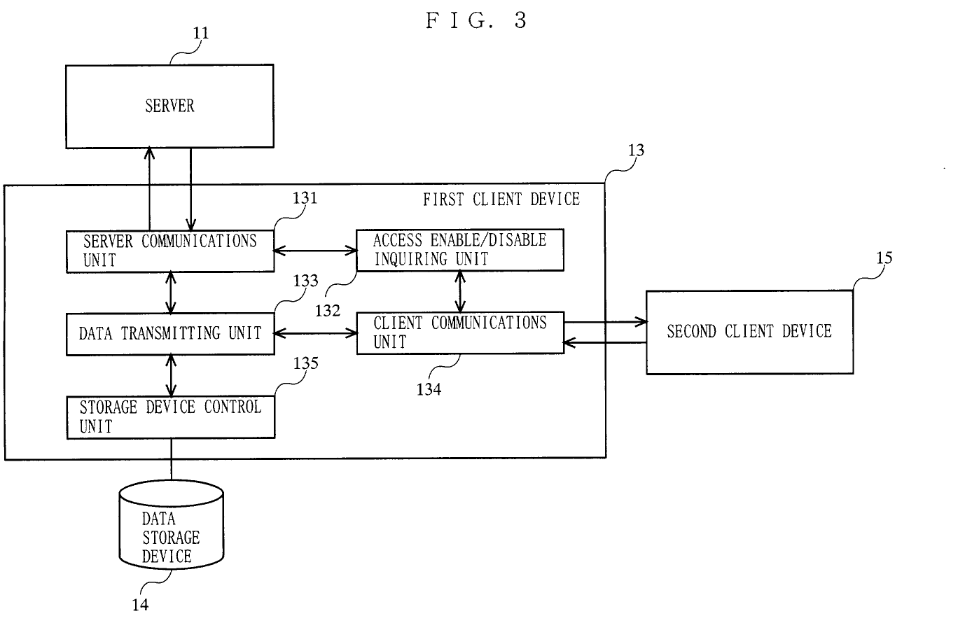

Next, with reference to FIG. 3, the internal construction of the first client device 13 is described. FIG. 3 is a functional block diagram illustrating the internal construction of the first client device 13. In FIG. 3, the first client device 13 includes a server communications unit 131, an access enable/disable inquiring unit 132, a data transmitting unit 133, a client communications unit 134, and a storage device control unit 135. The server communications unit 131 uses a protocol such as TCP/IP to carry out communications between the first client device 13 and the server 11. The client communications unit 134 uses a protocol such as TCP/IP to carry out communications between the first client device 13 and the second client device 15. When a request for a list of data stored in the data storage device 14 comes from the second client device 15 via the client communications unit 134, the data transmitting unit 133 generates, under the control of the storage device control unit 135, a list of the data stored in the data storage device 14, and supplies the data list to the second client device 15. When reported from the server 11 that access is enabled, the data transmitting unit 133 retrieves the requested data from the data storage device 14 through the control of the storage device control unit 135, and transmits the data to the second client device 15 under the control of the client communications unit 134. The access enable/disable inquiring unit 132 inquires, when receiving a data request from the second client device 15, the server 11 via the server communications unit 131 to determine whether the data can be provided. Note that the first client device 13 has a unique identifier, which is stored in an identifier storage unit (not shown). This identifier may be information uniquely provided to the CPU incorporated in the first client device 13, or may be an IP address.

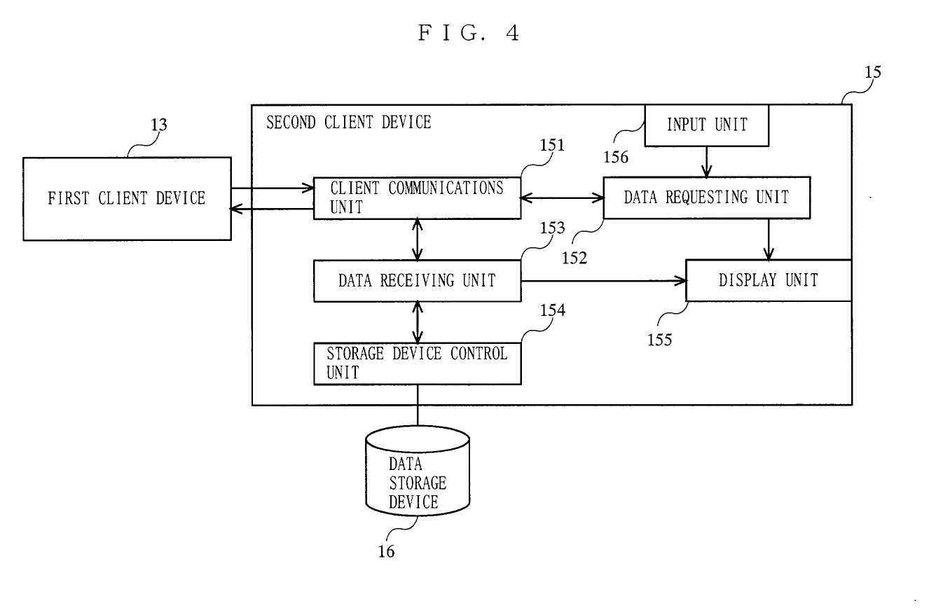

Next, with reference to FIG. 4, the internal construction of the second client device 15 is described. FIG. 4 is a functional block diagram illustrating the internal construction of the second client device 15. In FIG. 4, the second client device 15 includes a client communications unit 151, a data requesting unit 152, a data receiving unit 153, a storage device control unit 154, a display device 155, and an input device 156. The client communications unit 151 uses a protocol such as TCP/IP to carry out communications between the first and second client devices 13 and 15. The display device 155 displays, for example, the data list received through the client communications unit 151 from the first client device 13 to prompt a user of the second client device 15 to select desired data. The input device 156 is operated by the user to select the desired data from the data list. The data requesting unit 152 carries out communications through the client communications unit 151 with the first client device 13 for requesting the data. When the data request is allowed, the data receiving unit 153 receives the data from the first client device 13 through the client communications unit 151. Then, the storage device control unit 154 controls the data storage device 16 to store the data therein. Note that the second client device 15 has a unique identifier, which is stored in an identifier storage unit (not shown). This identifier may be information uniquely provided to the CPU incorporated in the second client device 15, or may be an IP address.

In the present embodiment, the first and second client devices 13 and 15 are different in construction. Such difference comes from the above-described assumption that the first client device 13 is a data-provider device and the second client device 15 is a data-destination device. Therefore, when it is convenient for both of the first and second client devices 13 and 15 to be able to provide and receive data, both devices are provided with the functions of both.

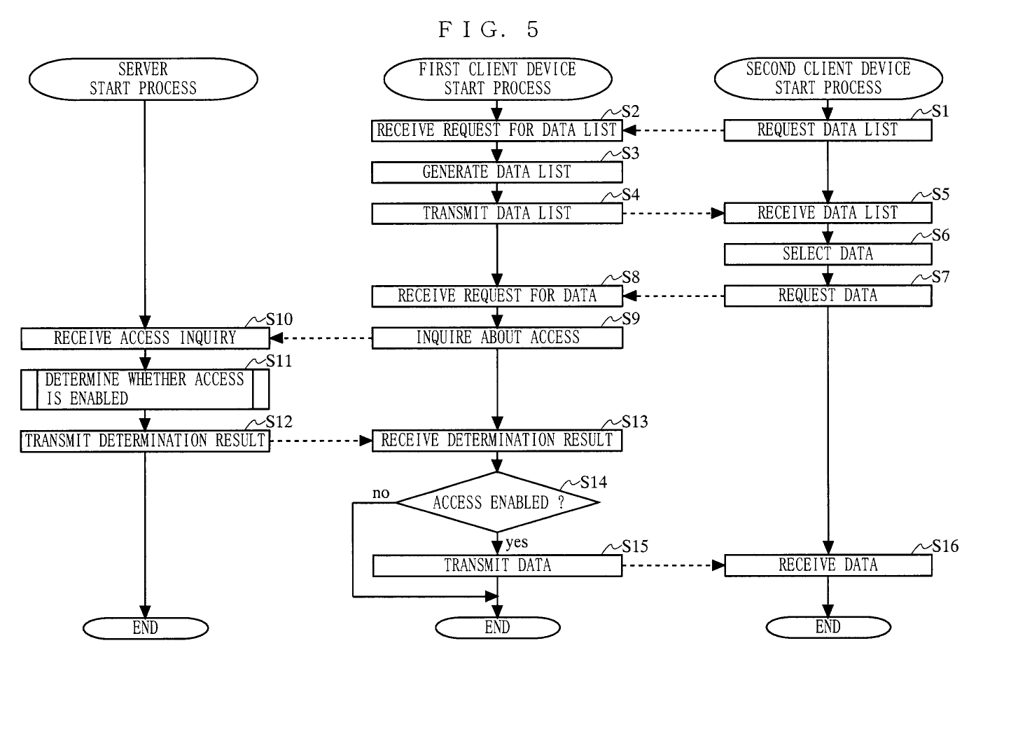

Next, with reference to FIG. 5, the entire processing of the access control system is described. FIG. 5 is a flowchart showing the operations carried out by the server 11 and the first and second client devices 13 and 15 configuring the access control system. For describing the entire operations in the access control system, it is assumed that the first client device 13 is a data-provider device and the second client device 15 is a data-destination device. Also, described is a case where the second client device 15 retrieves desired data stored in the data storage device 14 managed by the first client device 13. The operations in the access control system are carried out by access control programs respectively corresponding to the server 11 and the first and second client devices 13 and 15 being stored in a storage area included in the respective devices. These access control programs, however, may be stored in another storage medium as long as they can be read and executed by the server 11 and the first and second client devices 13 and 15.

In FIG. 5, to request a list of the data managed by the first client device 13, the data requesting unit 152 of the second client device 15 requests the first client device 13 for the data list (step S1). In step S1, the user of the second client device 15 operates the input device 156 to transmit a request for the data list to the data requesting unit 152. Then, the data requesting unit 152 requests the first client device 13 through the client communications unit 151 for the data list.

Next, the client communications unit 134 of the first client device 13 receives the request for the data list from the second client device 15, and reports the request for the data list to the data transmitting unit 133 (step S2). The data transmitting unit 133 then searches the data managed by the data storage device 14 by controlling the storage device control unit 135, and generates a list of the data managed by the data storage device 14 (step S3). The data transmitting unit 133 transmits the data list generated in step S3 to the second client device 15 through the client communications unit 134 (step S4).

Next, the client communications unit 151 of the second client device 15 receives the data list transmitted in step S4 from the first client device 13, and the display device 155 of the second client device 15 displays the received data list (step S5). Then, the user of the second client device 15 operates the input device 156 to select the desired data from the data list displayed on the display device 155, and reports the selection result to the data requesting unit 152 (step S6). The data requesting unit 152 then transmits the file name of the data selected in step S6 and a data-destination identifier for identifying itself (that is, the identifier of the second client device 15) to the first client device 13 through the client communications unit 151 for requesting the data (step S7).

The client communications unit 134 of the first client device 13 receives the file name of the data requested by the second client device 15 and the data-destination identifier, and forwards them to the access enable/disable inquiring unit 132 (step S8). Then, to determine whether access to the data requested by the second client device 15 is enabled, the access enable/disable inquiring unit 132 sends the file name, the data-destination identifier, and a data-provider identifier (that is, the identifier of the first client device 13) to the server 11 through the server communications unit 131 for giving an inquiry about the request (step S9).

The client communications unit 113 of the server 11 then sends the file name, the data-destination identifier, and the data-provider identifier, which have been sent by the first client device 13 as the inquiry about the request, to the access enable/disable determining unit 111 (step S10). The access enable/disable determining unit 111 then refers to the access management list stored in the access management database storage device 12 by controlling the database control unit 112 to determine whether the requested data can be accessed (step S11). The operation of the access determining process in step S11 will be described in detail later. The access enable/disable determining unit 111 then sends the determination result with respect to the data requested in step S11 to the first client device 13 through the client communications unit 113 (step S12). Also, when the registered data referred to in step S11 from the access management list contains a limitation of “duplicate condition”, which will be described later, information indicating the duplicate condition (hereinafter, duplicate condition information) is also transmitted in step S12 to the first client device 13.

The server communications unit 131 of the first client device 13 then receives the access determination result transmitted from the server 11, and then forwards it to the data transmitting unit 133 (step S13). The data transmitting unit 133 then determines whether the data requested in step S8 from the second client device 15 can be accessed based on the access determination result (step S14). If the access determination result indicates that the data can be accessed, the data transmitting unit 133 controls the storage device control unit 135 to search the data storage device 14 for the data requested in step S8 from the second client device 15, and transmits the found data to the second client device 15 through the client communications unit 134 (step S15). When the duplicate condition information is simultaneously transmitted in step S12, the requested data is transmitted to the second client device 15 together with the duplicate condition information. If the access determination result indicates that the data can not be accessed, on the other hand, the data transmitting unit 133 rejected data transmission to the second client device 15.

The client communications unit 151 of the second client device 15 then receives the data transmitted in step S15, and forwards it to the data receiving unit 153 (step S16). The data receiving unit 153 then controls the storage device control unit 154 to store the data received in step S16 in the data storage device 16 or make the data displayed on the display device 155. When the data is received in step S16 together with the duplicate condition information, the data is limited under the duplicate condition information as to future duplication. This limitation of duplication will be described later.

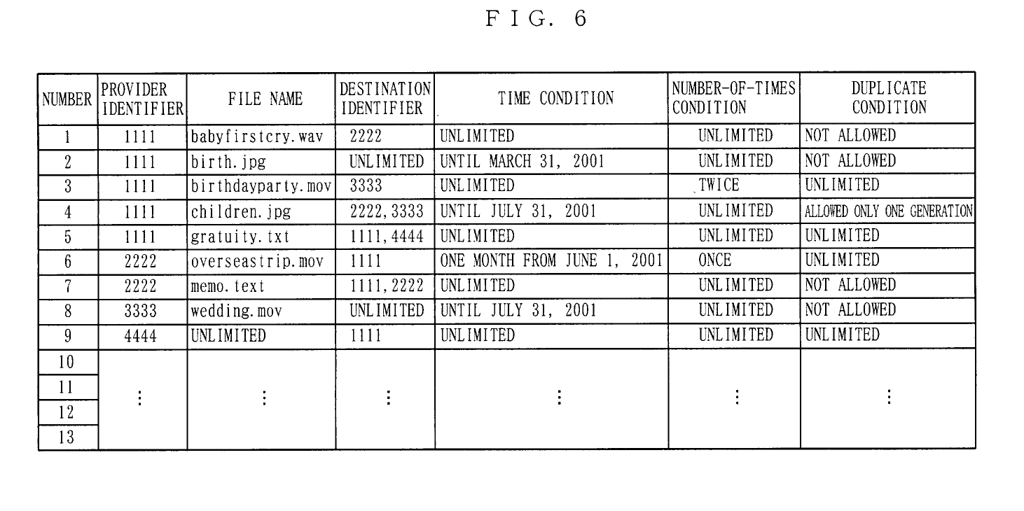

Next, with reference to FIG. 6, described is the data structure of the access management list stored in the access management database storage device 12. FIG. 6 is an example of the access management list stored in the access management database storage device 12. In FIG. 6, the access management list stored in the access management database storage device 12 contains data composed of seven items, that is, “number”, “data-provider identifier”, “file name”, “data-destination identifier”, “time condition”, “number-of-times condition”, and “duplicate condition”.

In the access management list, “number” indicates a natural number uniquely provided for managing each registered data in the access management database storage device 12.

In the access management list, “data-provider identifier” indicates an identifier uniquely provided to each client device for specifying a data-provider client device.

In the access management list, “file name” indicates a file name of the data to be accessed. Note that the file name may be a content ID, which is identification information unique to a content to be accessed.

In the access management list, “data-destination identifier” indicates an identifier unique to each client device for specifying a data-destination client device. Note that “data-destination identifier” can specify not only a specific client device but also can contain “unlimited” if the data can be accessed by any client device. Also, if the data cannot be accessed by any client device, “data-destination identifier” contains “unlimited” or no description.

In the access management list, “time condition” indicates a time limitation for specifying a date when the data can be allowed to be provided, or a duration during which the data can be provided. If no time limitation is provided for data access, “time condition” contains “unlimited”.

In the access management list, “number-of-times condition” indicates a limitation as to the number of times the data can be provided by the data-provider device. For the data whose “number-of-times condition” has any number of times set therein, when the server 11 allows access to the data, the set number of times is decremented for update. When the number of times becomes 0, further access is not allowed. If the data in the access management list can be accessed at any number of times, “number-of-times condition” contains “unlimited”.

In the access management list, “duplicate condition” indicates a limitation of whether the data-destination device is allowed to duplicate the data. If no duplication is allowed in the data-destination device, “duplicate condition” contains “not allowed”. If duplication is allowed without any specific limitations, “duplicate condition” contains “unlimited”. If the number of generations of duplications is limited, “duplicate condition” contains the number of generations (for example, “allowed only one generation” for “number” 4).

Each registered data is contained by each of the items described above in the access management list. For example, registered data having “1” contained in “number” is the one for managing access to an audio file whose “file name” is “babyfirstcry.wav” stored in the client device whose “data-provider identifier” is “1111”. This audio file can be accessed only by the device whose “data-destination identifier” is “2222”. There are no limitations as to the date and the number of times of allowable access by the device with the identifier “2222”. The data-destination device with the identifier “2222” is not allowed to further duplicate the provided file “babyfirstcry.wav”.

Also, for example, registered data having “4” contained in “number” is the one for managing access to an image file whose “file name” is “children.jpg” stored in the client device whose “data-provider identifier” is “1111”. This image file can be accessed only the devices whose “data-destination identifier” are “2222” and “3333”, respectively. The devices with the identifiers “2222” and “3333” can access the image file until Jul. 31, 2002, as limited in “time condition”, and cannot access the image file thereafter. The number of times of access by the devices with the identifiers “2222” and “3333” is unlimited. Also, the devices with the identifiers “2222” and “3333” are allowed to further duplicate the provided file “children.jpg” for only one generation.

Furthermore, registered data having “9” contained in “number” is the one for managing special access. This registered data is for managing access of a device whose “data-provider identifier” is “4444” to a device whose “data-destination identifier” is “1111”, but “file name” contains “unlimited”. That is, all files stored in the device with “4444” can be accessed by the device with “1111”. Such usage maybe used when the devices with “1111” and “4444” are both owned by the same person and therefore unconditional access to the files are allowed, for example.

The registered data is contained in the access management list stored in the access management database storage device 12 under either one of the following conditions:

Condition 1: Of all data managed by all client devices whose accesses are managed by the server 11, data unconditionally providable or providable under a certain condition to other client devices is contained in the access management list (that is, data not contained in the access management list cannot be accessed).

Condition 2: Of all data managed by all client devices whose accesses are managed by the server 11, data unprovidable or providable under a certain condition is contained in the access management list (that is, data not contained in the access management list can be accessed).

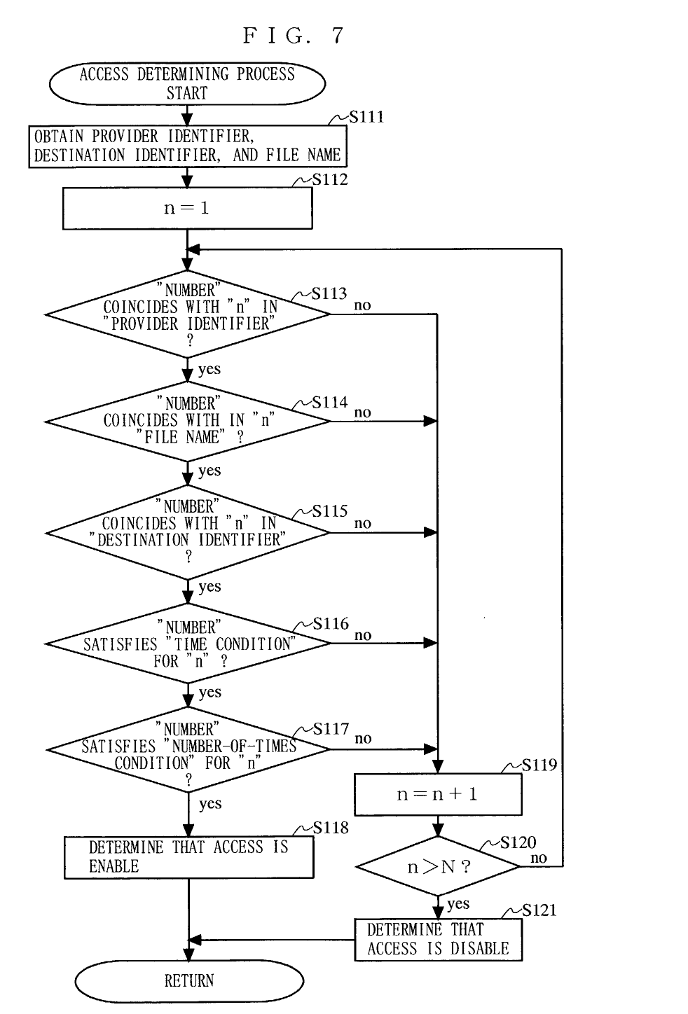

Described next in detail is an access determining process carried out by the access enable/disable determining unit 111 in step S11 (refer to FIG. 5). FIG. 7 is a subroutine of step S11 showing one example of the detailed access determining process carried out by the access enable/disable determining unit 111. Assume herein that the registered data is contained in the access management list stored in the access management database storage device 12 under the above Condition 1 (that is, data not contained in the access management list cannot be accessed).

In FIG. 7, the access enable/disable determining unit 111 receives an access inquiry including the data-provider identifier for identifying the data-provider client device, the data-destination identifier for identifying the data-destination client device, and the file name for identifying the data to be provided (step S111). Then, the access enable/disable determining unit 111 sets a temporary variable n for use in this subroutine to 1 for initialization (step S112).

The access enable/disable determining unit 111 determines whether the data-provider identifier received in step S111 coincides with that of the registered data having “n” contained in “number” in the access management list stored in the access management database storage device 12 (step S113). If the received data-provider identifier coincides with that, the procedure goes to step S114. Otherwise, the procedure goes to step S119.

In step S114, the access enable/disable determining unit 111 determines whether the file name received in step S111 coincides with the file name of the registered data whose “number” is n. As described above, “file name” in the access management list may contain “unlimited”. In this case, the access enable/disable determining unit 111 determines that the file name received in step S111 coincides with the one contained in “file name” in the access management list. Then, if the received file name coincides with the one contained in “file name”, the procedure goes to step S115. Otherwise, the procedure goes to step S119.

In step S115, the access enable/disable determining unit 111 determines whether the data-provider identifier received in step S111 coincides with the one contained “data-provider identifier” of the registered data whose “number” is “n” in the access management list. As described above, “data-provider identifier” in the access management list may contain “unlimited”. In this case, the access enable/disable determining unit 111 determines that the data-provider identifier coincides with the one contained in “data-provider identifier” in the access management list. Then, if the received data-provider identifier coincides with the one contained in “data-provider identifier”, the procedure goes to step S116. Otherwise, the procedure goes to step S119.

In step S116, the access enable/disable determining unit 111 compares the current time with the one contained in “time condition” of the registered data whose “number” is “n” in the access management list to determine whether access is enabled or disabled. In this comparison carried out by the access enable/disable determining unit 111, it is determined that access is enabled if “time condition” contains “unlimited”. If “time condition” contains a temporal limitation, whether access is enabled or disabled is determined based on whether the current time satisfies the temporal limitation. Then, if it is determined that access is enabled, the procedure goes to step S117. Otherwise, the procedure goes to step S119.

In step S117, the access enable/disable determining unit 111 refers to “number-of-times condition” of the registered data whose “number” is “n” in the access management list to determine whether access is enabled or disabled. In this determination carried out by the access enable/disable determining unit 111, it is determined that access is enabled if “number-of-times condition” contains “unlimited” or “once or more”. If “number-of-times condition” contains “0”, it is determined that access is disabled. After determining that access is enabled based on “number of times condition” containing “once or more”, the access enable/disable determining unit 111 updates the access management list by decrementing the number of times contained in “number-of-times condition” by 1. Then, if the access enable/disable determining unit 111 determines in step S117 that access is enabled, the procedure goes to step S118. If the access enable/disable determining unit 111 determines in step S117 that access is disabled, the procedure goes to step S119.

In step S117, an example scheme of how to update “number-of-times condition” in the access management list has been described, wherein the number of times for access by any client device is always decremented by 1 if it is determined that access is enabled. When “data-destination identifier” contains a plurality of identifiers (that is, there are a plurality of data-destination client devices), however, “number-of-times condition” may not be shared among the data-destination client devices, but may be set for each data-destination client device.

In step S118, the access enable/disable determining unit 111 determines that access is enabled in response to the access inquiry received in step S111, and ends the subroutine. The procedure can go to this step S118 only when it is determined through steps S113 to S117 that every item of the access inquiry received in step S111 by the access enable/disable determining unit 111 coincides with the corresponding one in the access management list through the steps S113 to S117 and also when every access condition is satisfied. Therefore, the access enable/disable determining unit 111 determines only for the client device having items that coincide with those of the registered data in the access management list and satisfying every condition.

As described above, on the other hand, if any item of the access inquiry received in step S111 does not satisfy conditions in steps S113 through S117, the procedure goes to step S119. In step S119, the access enable/disable determining unit 111 increments the temporary variable n by 1 to n+1 for further proceeding to step S120.

In step S120, the access enable/disable determining unit 111 determines whether the current temporary variable n is larger than the number of registered data items N in the access management list. If n>N, the access enable/disable determining unit 111 determines that all registered data items in the access management list have been processed, and then the procedure goes to step S121. If n≦N. on the other hand, the access enable/disable determining unit 111 determines that any registered data item in the access management list is left unprocessed, and the procedure returns to step S113 for carrying out the process on the data having “number” newly set in step S119.

In step S121, the access enable/disable determining unit 111 determines that access is disabled in response to the access inquiry received instep S111, and then ends the subroutine. Note that this step S121 is carried out when any item of the access inquiry received in step S111 by the access enable/disable determining unit 111 does not coincide with the corresponding one in the access management list through the steps S113 to S117 and also when any access condition is not satisfied. Therefore, the access enable/disable determining unit 111 determines for the client device that does not coincide with any item of the registered data in the access management list or does not satisfy with any condition.

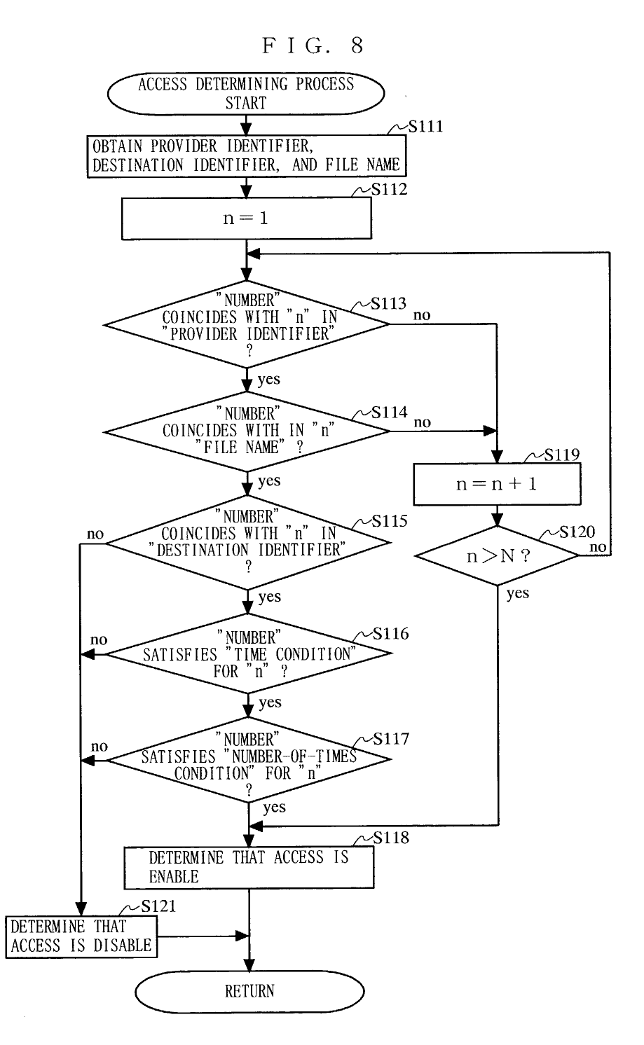

The access determining process carried out by the access enable/disable determining unit 111 as described with reference to FIG. 7 has been described in a case where the registered data is contained in the access management list stored in the access management database storage device 12 based on the above Condition 1. Alternatively, the registered data may be contained based on the above Condition 2 (that is, the data not contained in the access management list can be accessed). In this case, the access determining process is changed only in the following step. That is, with reference to FIG. 8, if the access enable/disable determining unit 111 determines “no” in steps S115 to S117, the procedure goes to step S121, wherein the access enable/disable determining unit 111 determines that access is disabled in response to the access inquiry received in step S111, and ends the subroutine. If n>N in step S120, the procedure goes to step S118, wherein the access enable/disable determining unit 111 determines that access is enabled in response to the access inquiry received in step S111, and ends the subroutine. As such, the access enable/disable determining unit 111 uses an appropriate procedure depending on the condition used for generating the access management list to appropriately determine whether access is enabled or disabled.

Note that, in the first embodiment, any scheme for certifying the first and second client devices 13 and 15 has not been mentioned. However, authentication may be made between the server 11 and the first and second client devices 13 and 15 for certifying that communications is made by an authorized client device. That is, for communications from the second client device 15 to the first client device 13, a certificate that certifies the second client device 15 (hereinafter, second certificate) is transmitted from the second client device 15 to the server 11. For communications from the first client device 13 to the server 11, the second certificate that certifies the second client device 15 and a certificate that certifies the first client device 13 (hereinafter, first certificate) are transmitted to the server 11. Thus, by receiving these certificates, the server 11 can confirm that communications is made by authorized client devices. An example certificate may be an X.509 certificate, which provides a standard way is a public-key certificate and a certificate revocation list.

Also, when the server 11 transmits the access determination result together with duplicate condition information to the first client device 13, the server 11 carries out predetermined encryption on the duplicate condition information. For example, the server 11 uses its secret key to place a signature on the duplicate condition information, thereby ensuring for the second client device 15 the data to which the duplicate condition is applied. The data to which this duplicate condition is applied is encrypted by a DRM (Digital Rights Management) scheme. For example, when the first client device 13, which is a data-provider device, receives the access determination result together with the duplicate condition information from the server 11, the first client device 13 encrypts the data to which the duplicate condition information is applied with a public key of the second client device 15, and transmits the encrypted data and the duplicate condition information to the second client device 15. The second client device 15 stores a secret key in a tamper-resistant area for keeping it secret to even the user of the device. Thus, even if the data is duplicated by unauthorized device (other than the second client device 15), the data cannot be decoded, and therefore duplication is restricted. Furthermore, when the data is duplicated under the duplicate condition, duplication can be restricted by once decoding the encrypted data with the secret key of the second client device 15, and then again encrypting the decrypted data with the public key of the duplication-destination device. Here, although the data is directly encrypted with the public key, the data may be encrypted with an encryption key of a common-key scheme, the used encryption key may be further encrypted by the first client device 13 with a public key of the second client device 15, and then the encrypted encryption key may be transmitted together with the encrypted data. If the signature placed on the duplicate condition information is tampered one (that is, the information does not come from the server 11), the data to which the duplicate condition information is applied cannot be duplicated.

In the first embodiment, any specific scheme for achieving security and tamper-resistance of a route for communications carried out between the server 11 and the first and second client devices 13 and 15 has not been described. However, encrypted communications may be carried out with an encryption scheme in combination of a secret-key scheme and a session-key scheme. Example encrypted communications can use SSL (Secure Socket Layer).

Also, in the first embodiment, the first client device 13 generates, in step S3, a list of the data stored in the data storage device 14 managed by itself. Alternatively, the data list may contain only data that can be accessed by the second client device 15. In this case, the first client device 13 receives, in step S2, a request for the data list from the second client device 15, and gives an access inquiry to the server 11 for receiving information about which data can be accessed by the second client device 15. Based on the received information, the first client device 13 generates the data list containing only the data that can be accessed by the second client device 15. Note that, with such data list, the first client device 13 may again give an access inquiry to the server 11 even after the second client device 15 gives a data request.

As such, according to the access control system of the first embodiment, the data-provider client device gives an access inquiry to the server. With this, access control for peer-to-peer data exchange is carried out by the server, which is high in processing capability. Therefore, it is possible to appropriately carry out even complex access control. With complex access control being achieved, data itself is directly exchanged between the client devices, thereby enabling data exchange without imposing a large load on the band of the network. Furthermore, even if the client device is implemented by a consumer-electronics product having a limited processing capability, the above complex access control is carried out by the server. Therefore, peer-to-peer data exchange between consumer-electronics products having a limited processing capability can be easily carried out by adding the above complex access control thereto.

(Second Embodiment)

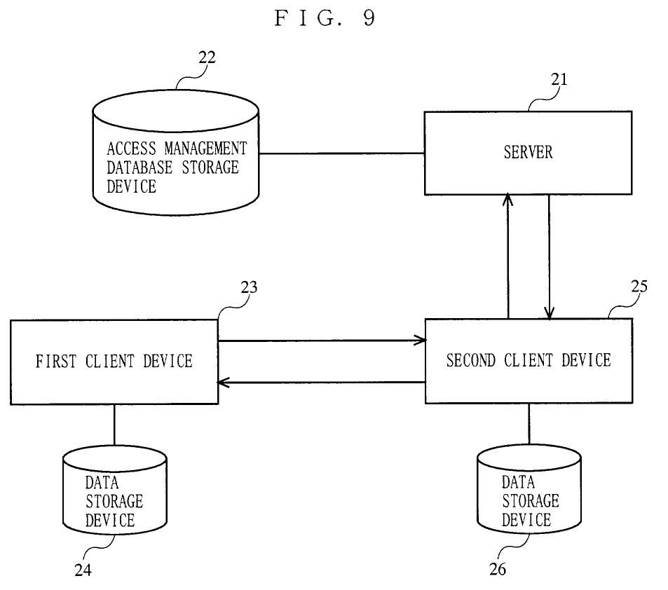

With reference to FIG. 9, described is the entire configuration of the access control system according to a second embodiment of the present invention. Note that, in the first embodiment, the data-provider client device (that is, the first client device 13 to be accessed) gives an access inquiry to the server 11. In the second embodiment, on the other hand, the data-destination client device (that is, the accessing client device) gives an access inquiry to the server.

In FIG. 9, the access control system includes a server 21, an access management database storage device 22, a first client device 23, a data storage device 24, a second client device 25, and a data storage device 26. The first and second client devices 23 and 25 are end-users' devices each having a CPU and achieving peer-to-peer computing by direct communications with each other, thereby forming a peer-to-peer file exchange system. The server 21 is communicably connected to the client device placed in the peer-to-peer file exchange system and can be accessed by at least the first client device 25. The data storage devices 24 and 26 are storage devices each storing files or others managed by the first and second client devices 23 and 25, respectively. The access management database storage device 22 is a storage device that stores an access management list (will be described later) managed by the server 21, and others.

In the present embodiment, for the sake of simplification, it is assumed that the second client device 25 access the first client device 23 to receive a desired filed stored in the data storage device 24 managed by the first client device 23. Therefore, the first client device 23 is a data-provider client device, while the second client device 25 is a data-destination client device. Also, in the access control system, three or more client devices can be placed, but only the client devices engaging the above-described file access are described.

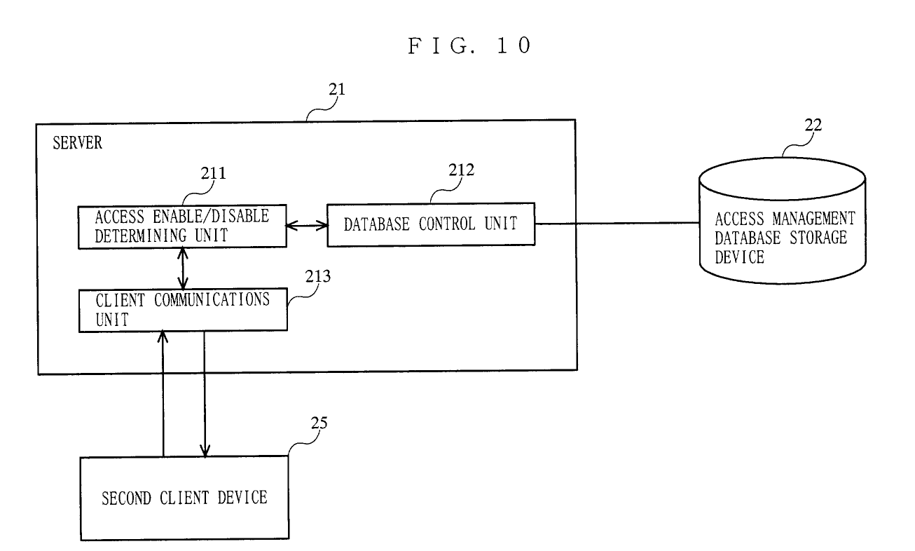

Next, with reference to FIG. 10, the internal construction of the server 21 is described. FIG. 10 is a functional block diagram illustrating the internal construction of the server 21. In FIG. 10, the server 21 includes an access enable/disable determining unit 211, a database control unit 212, and a client communications unit 213. The client communications unit 213 uses a protocol such as TCP/IP to carry out communications between the second client device 25 and the server 21. The database control unit 212 controls the data stored in the access management database storage device 22. For example, the database control unit 212 searches the access management database storage device 22 for specific data requested by the access enable/disable determining unit 211, and updates the data after search. Also, the database control unit 212 adds new data to or delete the existing data from the data stored in the access management database storage device 22 upon request from the client device via the client communications unit 213. Upon request from the second client device 25 via the client communications unit 213, the access enable/disable determining unit 211 refers to the access management list stored in the access management database storage device 22 to return the determination result to the client communications unit 213. Depending on the determination result, when the access management list has to be updated, the access enable/disable determining unit 211 instructs the database control unit 212 to update the list.

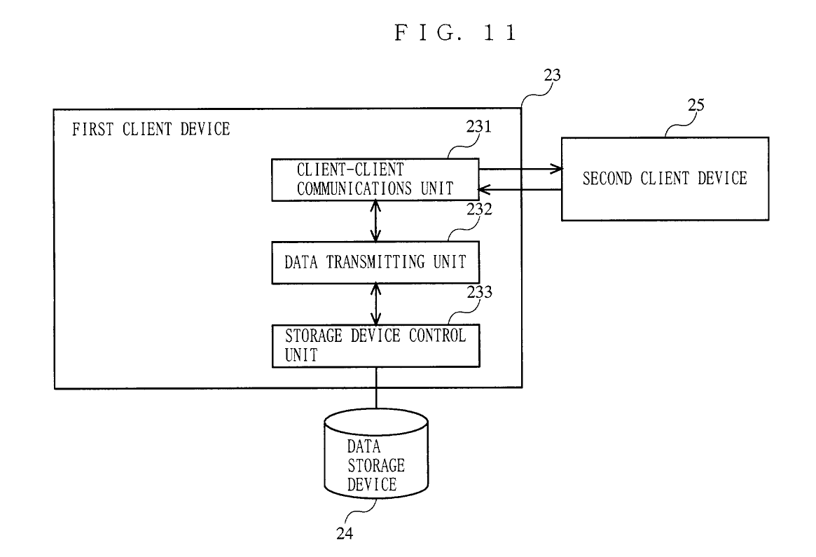

Next, with reference to FIG. 11, the internal construction of the first client device 23 is described. FIG. 11 is a functional block diagram illustrating the internal construction of the first client device 23. In FIG. 11, the first client device 23 includes a client communications unit 231, a data transmitting unit 232, and a storage device control unit 233. The client communications unit 231 uses a protocol such as TCP/IP to carry out communications between the first client device 23 and the second client device 25. When a request for a list of data stored in the data storage device 24 comes from the second client device 25 via the client communications unit 231, the data transmitting unit 232 generates, through the storage device control unit 233, a list of the data stored in the data storage device 24, and supplies the data list to the second client device 25. When reported from the second client device 25 that the server 21 has determined that access is enable, the data transmitting unit 232 retrieves the requested data from the data storage device 24 through the storage device control unit 233, and transmits the data to the second client device 25 under the control by the client communications unit 231. Note that the first client device 23 has a unique identifier, which is stored in an identifier storage unit (not shown). This identifier may be information uniquely provided to the CPU incorporated in the first client device 23, or may be an IP address.

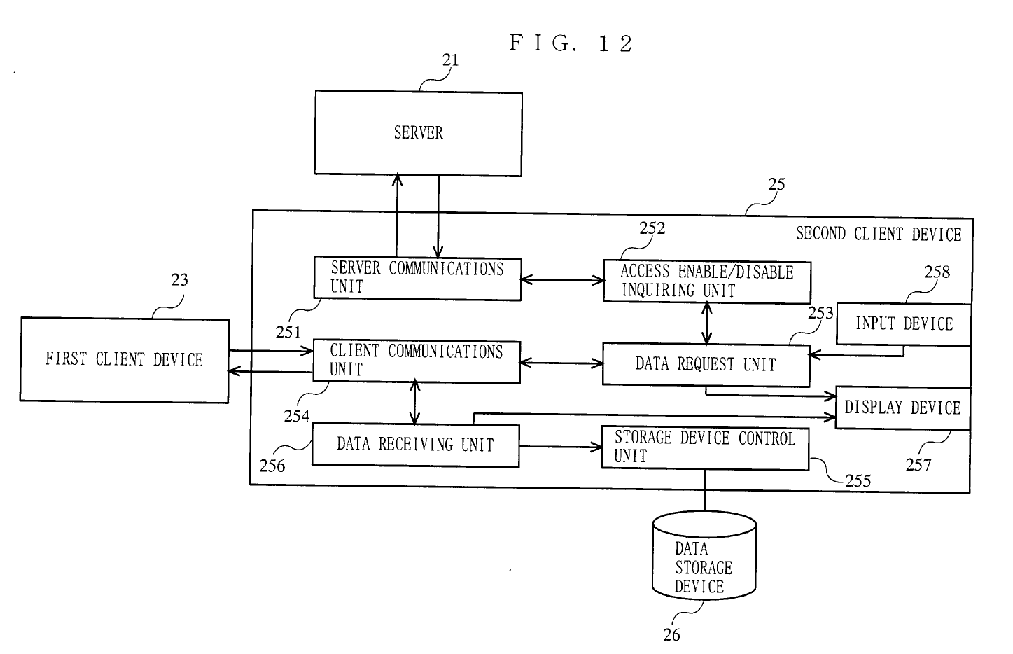

Next, with reference to FIG. 12, the internal construction of the second client device 25 is described. FIG. 12 is a functional block diagram illustrating the internal construction of the second client device 25. In FIG. 12, the second client device 25 includes a server communications unit 251, an access enable/disable inquiring unit 252, a data requesting unit 253, a data requesting unit 253, a client communications unit 254, a storage device control unit 255, a data receiving unit 256, a display device 257, and an input device 258. The server communications unit 251 uses a protocol such as TCP/IP to carry out communications between the second client device 25 and the server 21. The display device 257 displays, for example, the data list received through the client communications unit 254 from the first client device 23 to prompt a user of the second client device 25 to select desired data. The input device 258 is operated by the user to select the desired data from the data list. The data requesting unit 253 instructs the access enable/disable inquiring unit 252 to inquire about whether access to the data selected by the user is enabled or disabled. Based on the determination result, the data requesting unit 253 then carries communications with the first client device 23 through the client communications unit 254 for requesting the data. When receiving the data request from the data requesting unit 253, the access enable/disable inquiring unit 252 gives an inquiry to the server 21 through the server communications unit 251 to determine whether the data can be accessed. When the data request is allowed, the data receiving unit 256 receives the data from the first client device 23 through the client communications unit 254. Then, the storage device control unit 255 controls the data storage device 26 to store the data therein. Note that the second client device 25 has a unique identifier, which is stored in an identifier storage unit (not shown). This identifier may be information uniquely provided to the CPU incorporated in the second client device 25, or may be an IP address.

In the present embodiment, the first and second client devices 23 and 25 are different in construction. Such difference comes from the above-described assumption that the first client device 23 is a data-provider device and the second client device 25 is a data-destination device. Therefore, when it is convenient for both of the first and second client devices 23 and 25 to be able to provide and receive data, both devices , both devices are provided with the functions of both.

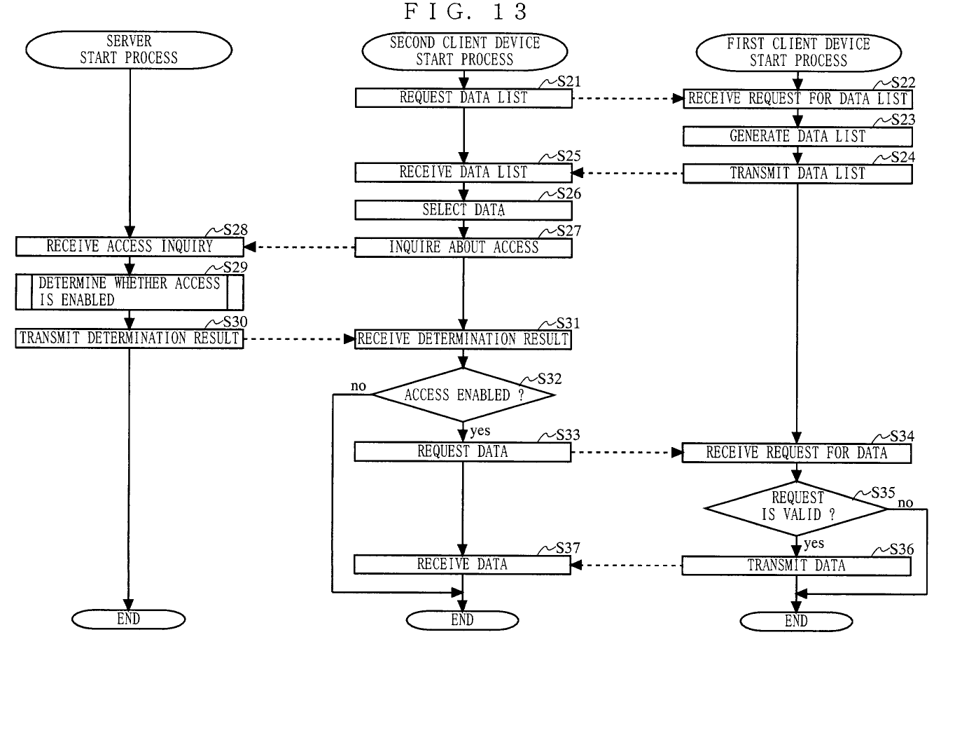

Next, with reference to FIG. 13, the entire processing of the access control system according to the second embodiment is described. FIG. 13 is a flowchart showing the operations carried out by the server 21 and the first and second client devices 23 and 15 configuring the access control system. For describing the entire operations in the access control system, it is assumed that the first client device 23 is a data-provider device and the second client device 25 is a data-destination device. Also, described is a case where the second client device 25 retrieves desired data stored in the data storage device 24 managed by the first client device 23. The operations in the access control system are carried out by access control programs respectively corresponding to the server 21 and the first and second client devices 23 and 25 being stored in a storage area included in the respective devices. These access control programs, however, may be stored in another storage medium as long as they can be read and executed by the server 21 and the first and second client devices 23 and 25.

In FIG. 13, to request a list of the data managed by the first client device 23, the data requesting unit 253 of the second client device 25 requests the first client device 23 for the data list (step S21). In step S21, the user of the second client device 25 operates the input device 258 to transmit a request for the data list to the data requesting unit 253. Then, the data requesting unit 253 requests the first client device 23 through the client communications unit 254 for the data list.

Next, the client communications unit 231 of the first client device 23 receives the request for the data list from the second client device 25, and reports the request for the data list to the data transmitting unit 232 (step S22). The data transmitting unit 232 then searches the data managed by the data storage device 24 by controlling the storage device control unit 233, and generates a list of the data managed by the data storage device 24 (step S23). The data transmitting unit 232 transmits the data list generated in step S23 to the second client device 25 through the client communications unit 231 (step S24).

Next, the client communications unit 254 of the second client device 25 receives the data list transmitted in step S24 from the first client device 23, and the display device 257 of the second client device 25 displays the received data list (step S25). Then, the user of the second client device 25 operates the input device 258 to select the desired data from the data list displayed on the display device 257, and reports the selection result to the data requesting unit 253 (step S26). The data requesting unit 253 then transmits the file name of the data selected in step S26 and a data-provider identifier for identification (that is, the identifier of the first client device 23) to the access enable/disable inquiring unit 252. To determine whether the data requested by the data requesting unit 253 can be accessed, the access enable/disable inquiring unit 252 then transmits, to the server 21 through the server communications unit 251, the file name of the requested data, a data-provider identifier, and a data-destination identifier for identifying itself (that is, the identifier of the second client device 25), as an access inquiry for the request (step S27).

The client communications unit 213 of the server 21 forwards, to the access enable/disable determining unit 211, the file name of the data, the data-provider identifier, and the data-destination identifier received as the access inquiry transmitted from the second client device 25 (step S28). The access enable/disable determining unit 211 then refers to the access management list stored in the access management database storage device 22 by controlling the database control unit 212 to determine whether the requested data can be accessed (step S29). The operation of the access determining process in step S29 will be described in detail later. The access enable/disable determining unit 211 then uses a predetermined encryption scheme to encrypt the access determination result as to the data requested in step S29, and then transmits the encrypted result to the second client device 25 through the client communications unit 213 (step S30). Also, when the registered data referred to in step S29 from the access management list contains a limitation of “duplicate condition”, which will be described later, the duplication is also transmitted in step S30 to the second client device 25.

Encryption of the access determination result carried out in step S30 is to ensure authenticity of the access determination result obtained in the server 21. The authenticity can be ensured by, for example, encrypting the access determination result with a public key of the first client device 23 or by transmitting the access determination result together with data signed with a secret key of the server 21. That is, with encryption, tampering on the communications can be prevented. Also, when the authenticity of the first client device 23 is evaluated, which will be described later, it is possible to ensure that it is the server 21 that provided the access determination result.

The server communications unit 251 of the second client device 25 then receives the access determination result transmitted from the server 21, and then forwards it to the data requesting unit 253 (step S31). The data requesting unit 253 then determines whether the data requested in step S26 can be accessed based on the access determination result (step S32). If the access determination result indicates that the data can be accessed, the data requesting unit 253 transmits, to the first client device 23 through the client communications unit 254, the file name together with the access determination result transmitted from the server 21, thereby requesting the first client device 23 for the data (step S33). When the duplicate condition information is simultaneously transmitted in step S30, the requested data is transmitted to the first client device 23 together with the duplicate condition information. If the access determination result indicates that the data can not be accessed, on the other hand, the second client device 25 terminates requesting the first client device 23 for the data.

The client communications unit 231 of the first client device 23 then receives the file name of the data requested by the second client device 25 and the access determination result, and forwards them to the data transmitting unit 232 (step S34). The data transmitting unit 232 then evaluates the authenticity of the access determination result by determining, for example, whether the access determination result was obtained in the server 21 (step S35). In step S35. the data transmitting unit 232 decodes the access determination result encrypted by the server 21 to confirm its authenticity. If the access determination result can be authenticated, the data transmitting unit 232 searches the data storage device 24 for the data requested by the second client device 25 by controlling the storage device control unit 233, and transmits the found data to the second client device 25 through the client communications unit 231 (step S36). When the data is received in step S33 together with the duplicate condition information, the requested data is transmitted to the second client device 25 together with the duplicate condition information. If the access determination result cannot be authenticated, on the other hand, the data transmitting unit 232 rejects data transmission to the second client device 25.

The client communications unit 254 of the second client device 25 receives the data transmitted in step S36, and forwards it to the data receiving unit 256 (step S37). The data receiving unit 256 then controls the storage device control unit 255 to store the data received in step S37 in the data storage device 26 or gives the data displayed on the display device 257. When the data is received in step S37 together with the duplicate condition information, the data is limited under the duplicate condition information as to future duplication. This limitation of duplication will be described later.

The data structure of the access management list stored in the access management database storage device 22 is similar to the one according to the first embodiment described with reference to FIG. 6. Also, the detailed operation of the access determining process carried out in step S29 (refer to FIG. 13) by the access enable/disable determining unit 211 is similar to the subroutine according to the first embodiment described with reference to FIG. 7 or FIG. 8. That is, also in the second embodiment, the access enable/disable determining unit 211 can appropriately determine whether access is enabled or disabled, by using the procedure selected depending on which condition has been used for generating the access management list. Therefore, in the second embodiment, the data structure of the access management list and the detailed operation of the access determining process carried out by the access enable/disable determining unit 211 are not described.

Note that, in the second embodiment, the first client device 23 generates the data stored in the data storage device 24 managed by itself as the data list. Alternatively, the data list may be obtained from the server 21 by the second client device 25 inquiring about only the data that can be accessed through the first client device 23. Specifically, the second client device 25 gives an access inquiry to the server 21 by transmitting a request for the data list in step S21 so that the server 21 returns the data list that can be accessed. The server 21 then searches the access management list for the data that can be accessed by the second client device 25 to generate the data list. Thus, it is possible to generate the data list containing only the accessible data and transmits the data list to the second client device 25.

Furthermore, in the second embodiment, any scheme for certifying the second client devices 25 has not been mentioned. However, authentication may be made between the server 21 and the first and second client devices 23 and 25 for certifying that communications is made by an authorized client device. That is, for communications from the second client device 25 to the first client device 23 or the server 21, a certificate that certifies the second client device 25 (hereinafter, second certificate) is transmitted to the first client device 23 or the server 21. Thus, by receiving these certificates, the first client device 23 and the server 21 can check that communications is made by the authorized client device. An example certificate may be an X.509 certificate, which provides a standard way is a public-key certificate and a certificate revocation list.

Still further, when the server 21 transmits the access determination result together with duplicate condition information to the second client device 25, the server 21 carries out predetermined encryption on the duplicate condition information. For example, the server 21 uses its secret key to place a signature on the duplicate condition information, thereby ensuring for the second client device 25 the data to which the duplicate condition is applied. The data to which this duplicate condition is applied is encrypted by a DRM (Digital Rights Management) scheme. For example, when the first client device 23, which is a data-provider device, receives the access determination result together with the duplicate condition information from the server 21, the first client device 23 encrypts the data to which the duplicate condition information is applied with a public key of the second client device 25, and transmits the encrypted data and the duplicate condition information to the second client device 25. The second client device 25 stores a secret key in a tamper-resistant area for keeping it secret to even the user of the device. Thus, even if the data is duplicated by unauthorized device (other than the second client device 25), the data cannot be decoded, and therefore duplication is restricted. Furthermore, when the data is duplicated under the duplicate condition, duplication can be restricted by once decoding the encrypted data with the secret key of the second client device 25, and then again encrypting the decrypted data with the public key of the duplication-destination device. Here, although the data is directly encrypted with the public key, the data may be encrypted with an encryption key of a common-key scheme, the used encryption key may be further encrypted by the first client device 23 with a public key of the second client device 25, and then the encrypted encryption key may be transmitted together with the encrypted data. If the signature placed on the duplicate condition information is tampered one (that is, the information does not come from the server 21), the data to which the duplicate condition information is applied cannot be duplicated.

In the second embodiment, any specific scheme for achieving security and tamper-resistance of a route for communications carried out between the server 21 and the first and second client devices 23 and 25 has not been described. However, encrypted communications may be carried out with an encryption scheme in combination of a secret-key scheme and a session-key scheme. Example encrypted communications can use SSL (Secure Socket Layer).

As such, according to the access control system of the second embodiment, the data-destination client device gives an access inquiry to the server. With this, access control for peer-to-peer data exchange is carried out by the server, which is high in processing capability. Therefore, it is possible to appropriately carry out even complex access control. With complex access control being achieved, data itself is directly exchanged between the client devices, thereby enabling data exchange without imposing a large load on the band of the network. Furthermore, even if the client device is implemented by a consumer-electronics product having a limited processing capability, the above complex access control is carried out by the server. Therefore, peer-to-peer data exchange between consumer-electronics products having a limited processing capability can be easily carried out by adding the above complex access control thereto.

In the access control system according to the above first and second embodiments, the client device directly connected to the server requests the server to determine whether access is enabled or disabled, and the server transmits the determination result to the client device. Alternatively, the client device that gives the above request may not be directly connected to the server. The present invention can be achieved as long as the server communicably connected to the client device placed in the peer-to-peer file exchange system and the client device that gives the above request can communicate with each other through a proxy client device capable of directly communicating with the server (hereinafter, third client device). For example, in the first embodiment, if the first client device 13 cannot directly communicate with the server 11, they communicate with each other through the third client device, thereby constructing an access control system similar to that in the first embodiment. Also, in the second embodiment, if the second client device 25 cannot directly communicate with the server 21, they communicate with each other through the third client device, thereby constructing an access control system similar to that in the second embodiment. Needless to say, when the third client device is used for constructing an access control system in the above-described manner, a certificate that certifies the third client device (hereinafter, third certificate) can be used for authenticating the client devices and the server, thereby confirming that communications is made by authorized client devices.

While the invention has been described in detail, the foregoing description is in all aspects illustrative and not restrictive. It is understood that numerous other modifications and variations can be devised without departing from the scope of the invention.

What is claimed is:

1. An access control system in which, when a client device of an end-user is requested from another device to directly transmit data stored in the client device, it is determined whether the data can be accessed, the access control system comprising:
a server communicably connected to the client device and managing an access management list containing which data can be accessed,
the server including an access enable/disable determining unit operable to determine, in response to a data access inquiry, whether the data can be accessed with reference to the access management list and send a determination result, and
the client device including
an access enable/disable inquiring unit operable to give the access enable/disable determining unit the data access inquiry of whether the data can be accessed when the other device requests the client device to directly transmit the data; and
a data transmitting unit operable to directly transmit the requested data to the other device when the determination result received from the access enable/disable determining unit indicates that the data can be accessed.

2. The access control system according to claim 1, wherein
the access management list managed by the server contains which device can access which data managed by the client device,
the access enable/disable inquiring unit gives the access enable/disable determining unit the data access inquiry for each data requested to be transmitted, and
in response to the data access inquiry given by the access enable/disable inquiring unit, the access enable/disable determining unit determines whether the data can be accessed, and sends the determination result.

3. The access control system according to claim 2, wherein
the access management list further contains a time condition indicating an accessible time for each data, and
the access enable/disable determining unit determines whether the data can be accessed by referring to the time condition based on a time when the data access inquiry is received from the access enable/disable inquiring unit.

4. The access control system according to claim 2, wherein
the access management list further contains a number-of-times condition indicating the number of times of allowable access for each data, and
the access enable/disable determining unit determines whether the data can be accessed by referring to the number-of-times condition based on how many times the data has been accessed.

5. The access control system according to claim 2, wherein
the access management list further contains a duplicate condition indicating a duplication limitation provided for each data,
in response to the data access inquiry given by the access enable/disable inquiring unit, the access enable/disable determining unit determines whether the data can be accessed, and sends the determination result and the duplicate condition, and
the data transmitting unit directly transmits the requested data with the duplicate condition to the other device when the determination result received from the access enable/disable determining unit indicates that the data can be accessed.

6. The access control system according to claim 1, wherein
the server is communicably connected to the client device through a proxy device.

7. The access control system according to claim 1, wherein
the access enable/disable inquiring unit gives the access enable/disable determining unit the data access inquiry together with a first certificate that certifies the client device and a second certificate that certifies the other device, and
the access enable/disable determining unit authenticates the data access inquiry given by the access enable/disable inquiring unit by using the first and second certificates, then determines whether the data can be accessed and sends the determination result.

8. The access control system according to claim 7, wherein
the first and second certificates are X.509 certificates.

9. An access control system in which, when a first client device of an end-user is requested from a second client device to directly transmit data stored in the first client device, it is determined whether the data can be accessed, the access control system comprising:
a server communicably connected to at least the second client device and managing an access management list containing which data can be accessed,
the server including an access enable/disable determining unit operable to determine, in response to a data access inquiry, whether the data can be accessed with reference to the access management list and sending a determination result, and
the second client device including
an access enable/disable inquiring unit operable to give the access enable/disable determining unit the data access inquiry about whether the data can be accessed when the second client device requests the first client device to directly transmit the data; and
a data requesting unit operable to give a request to the first client device for directly transmitting the data together with the determination result received from the access enable/disable determining unit when the determination result indicates that the data can be accessed,
the first client device including
a data transmitting unit operable to directly transmit the data requested by the data requesting unit to the second client device when the determination result received from the data requesting unit indicates that the data can be accessed, and
the second client device further including
a data receiving unit operable to directly receive the data transmitted from the data transmitting unit in response to the request given by the data requesting unit.

10. The access control system according to claim 9, wherein
the access management list managed by the server contains which client device can access which data,
the access enable/disable inquiring unit gives the access enable/disable determining unit the data access inquiry for each data requested for transmission, and
in response to the data access inquiry given by the access enable/disable inquiring unit, the access enable/disable determining unit determines whether the data can be accessed, and sends the determination result.

11. The access control system according to claim 10, wherein
the access management list further contains a time condition indicating an accessible time for each data, and
the access enable/disable determining unit determines whether the data can be accessed by referring to the time condition based on a time when the data access inquiry is received from the access enable/disable inquiring unit.

12. The access control system according to claim 10, wherein
the access management list further contains a number-of-times condition indicating the number of times of allowable access for each data, and
the access enable/disable determining unit determines whether the data can be accessed by referring to the number-of-times condition based on how many times the data has been accessed.

13. The access control system according to claim 10, wherein
the access management list further contains a duplicate condition indicating a duplication limitation provided for each data,
in response to the data access inquiry given by the access enable/disable inquiring unit, the data access enable/disable determining unit determines whether the data can be accessed, and sends the determination result and the duplication condition,
the data requesting unit gives the request to the first client device for directly transmitting the data, together with the determination result and the duplicate condition when the determination result received from the access enable/disable determining unit indicates that the data can be accessed,
the data transmitting unit directly transmits, to the data receiving unit, the data requested from the data requesting unit and the duplicate condition when the determination result received from the data requesting unit indicates that the data can be accessed, and
the data receiving unit directly receives the data transmitted from the data transmitting unit, the data restricted in further duplication by the duplication condition.

14. The access control system according to claim 9, wherein
the server is communicably connected to the second client device through a proxy device.

15. The access control system according to claim 9, wherein
the access enable/disable inquiring unit gives the access enable/disable determining unit the data access inquiry to request the first client device for directly transmitting the data, together with a certificate that certifies the second client device, and
the access enable/disable determining unit authenticates the data access inquiry given by the access enable/disable inquiring unit by using the certificate, then determines whether the data can be accessed and then sends the determination result.

16. The access control system according to claim 15, wherein
the access enable/disable determining unit sends the determination result affixed with a signature for certifying that the determination result is from the server, and
the data requesting unit gives the first client device a request for directly transmitting the data together with the determination result affixed with the signature and the certificate, when the determination result received from the access enable/disable determining unit indicates that the data can be accessed, and
the data transmitting unit first authenticates the determination result received from the data requesting unit by using the signature affixed thereto, and then directly transmits, to the data receiving unit, the data requested from the data requesting unit and the duplicate condition, when the determination result indicates that the data can be accessed.

17. The access control system according to claim 15, wherein
the certificate is an X.509 certificate.

18. A server for determining whether data managed by a plurality of client devices of end-users can be accessed when the data is directly transmitted and received among the client devices, the server comprising:
an access managing unit operable to manage an access management list containing which data can be accessed by which client device; and
an access enable/disable determining unit operable to determine, in response to a data access inquiry given by one client device, whether the data can be accessed with reference to the access management list managed by the access managing unit, and send a determination result to the client device that has given the data access inquiry.

19. A client device of an end-user, the client device causing a communicable server to determine whether data stored in the client device can be accessed when another device gives the client device a request for directly transmitting the data, the server managing an access management list that contains which data can be accessed, the client device comprising:
an access enable/disable inquiring unit operable to give the server an inquiry about whether the data can be accessed when the other device gives the client device the request for directly transmitting the data; and
a data transmitting unit operable to directly transmit the data as requested by the other device when the server determines, in response to the inquiry given by the access enable/disable inquiring unit, that the data can be accessed.

20. A client device of an end-user, the client device causing a communicable server to determine whether data stored in another device can be accessed when the client device gives the other device a request for direct transmitting the data, the server managing an access management list that contains which data can be accessed, the client device comprising:
an access enable/disable inquiring unit operable to give the server an inquiry about whether the data can be accessed when the client device gives the other device the request for directly transmitting the data; and
a data requesting unit operable to give the other device the request for directly transmitting the data, and also give a determination result received from the server when the determination result indicates that the data can be accessed in response to the inquiry given by the access enable/disable inquiring unit.

21. A client device of an end-user for directly transmitting data upon request from another device, the client device comprising:
a receiving unit operable to receive a request from the other device for directly transmitting the data, and a determination result indicating whether the data can be accessed, and
a data transmitting unit operable to directly transmit the data requested by the other device when the determination result received by the receiving unit indicates that the data can be accessed.

22. The client device according to claim 21, wherein
the determination result is provided with a signature certifying the authenticity of the determination result, and
the data transmitting unit evaluates authenticity of the determination result by authenticating the signature provided on the determination result and, when the determination result is valid and indicates that the data can be accessed, directly transmits the data requested by the other device.

23. An access control method for causing, when a client device of an end-user is requested from another device to directly transmit data stored in the client device, a server communicably connected to the client device to determine whether the data can be accessed, the access control method comprising the steps of:
managing, by the server, an access management list containing which data can be accessed; and
giving, by the client device, the server an inquiry about whether the data requested from the other device for direct transmission can be accessed;
determining, by the server, whether the data can be accessed with reference to the access management list managed in the access managing step in response to the inquiry in the inquiring step, and sending a determination result to the client device; and
directly transmitting the requested data from the client device to the other device when the determination result obtained in the determining step indicates that the data can be accessed.

24. An access control method for causing, when a first client device of an end-user is requested from a second client device to directly transmit data stored in the first client device, a server communicably connected to a second client device to determine whether the data can be accessed, the access control method comprising the steps of:
managing, by the server, an access management list containing which data can be accessed;
giving, by the second client device, the server an inquiry about whether the data requested from the second client device to the first client device for direct transmission can be accessed;
determining, by the server, whether the data can be accessed with reference to the access management list managed in the access managing step in response to the inquiry in the inquiring step, and sending a determination result to the second client device;
giving, to the first client device, a request for directly transmitting the data and the determination result when the determination result sent in the determining step indicates that the data can be accessed;
directly transmitting the data requested in the request giving step from the first client device to the second client device when the determination result given in the request giving step indicates that the data can be accessed; and
directly receiving, by the second client device, the data transmitted from the first client device in the data transmitting step.

25. A recording medium recording an access control program for causing, when data managed by client devices of end-users is directly transmitted and received among the client devices, a server communicably connected to the client devices to determine whether the data can be accessed, the program readable by the server and comprising the steps of:
managing an access management list containing which data can be accessed by the respective client devices; and
determining whether the data can be accessed with reference to the access management list managed in the access managing step in response to a data access inquiry from the client device to the server as to direct transmission and reception of the data, and sending a determination result to the client device.

26. A recording medium recording an access control program for causing, when a client device of an end-user is requested from another device to directly transmit data stored in the client device, a communicable server to determine whether the data can be accessed, by using an access management list containing which data can be accessed, the recording medium readable by the client device and comprising the steps of:
giving the server an inquiry about whether the data can be accessed when the client device is requested from the other device to directly transmit the data; and
directly transmitting the requested data from the client device to the other device when a determination result received from the server indicates that the data can be accessed in response to the inquiry given in the inquiry giving step.

27. A recording medium recording an access control program for causing, when a client device of an end-user requests another device to directly transmit data stored in the other device, a communicable server to determine whether the data can be accessed, by using an access management list containing which data can be accessed, the recording medium readable by the client device and comprising the steps of:
giving the server an inquiry about whether the data can be accessed when the client device requests the other device to directly transmit the data; and
directly giving the other device a request for directly transmitting the data together with a determination result received from the server, when the determination result indicates that the data can be accessed in response to the inquiry given in the inquiry giving step.
